(19) United States
(12) Patent Application Publication
(10) Pub. No.: US 2014/0353265 A1
(43) Pub. Date: Dec. 4, 2014

(54) Illuminated Merchandise Dispenser

(71) Applicant: Vulcan Spring & Mfg. Co., Telford, PA (US)

(72) Inventors: Alexander Rankin, VI, Dresher, PA (US); Robert Gustafson, Collegeville, PA (US)

(73) Assignee: Vulcan Spring & Mfg. Co., Telford, PA (US)

(21) Appl. No.: 14/285,167

(22) Filed: May 22, 2014

Related U.S. Application Data
(60) Provisional application No. 61/829,488, filed on May 31, 2013.

(51) Int. Cl. A47F 1/12; F21V 33/00; F21K 99/00

(52) U.S. Cl. CPC A47F 1/126; F21K 9/00; F21V 33/0004; F21Y 2103/003
USPC 211/59.3; 362/217.16

(57) ABSTRACT

A merchandise dispenser is provided and has a product display tray with a bottom portion for supporting and guiding a rank of product items. The merchandise dispenser also has a spring assembly for advancing the product items forward on the bottom portion. The spring assembly includes a pre-stressed spiral tape having a top surface extending from a mounting end portion thereof and a plurality of light emitting diodes carried in spaced relation on a predetermined length of the top surface of the tape for upwardly illuminating product items when disposed in the product display tray.

### CROSS-REFERENCE TO RELATED APPLICATION

This application claims the benefit under 35 USC §119(e) of U.S. Provisional Patent Application No. 61/829,488, filed May 31, 2013.

### BACKGROUND

The present invention relates to merchandise dispensers that advance a rank of products frontward in a tray as forwardmost products are removed in sequence.

An example of a merchandise dispenser that includes an adjustable spring-powered feature is disclosed in U.S. Pat. No. 6,464,089 to A. Rankin, VI. The patented Rankin mechanism includes a track mounting an upright pusher that slides along the track. The front of the pusher engages product packages. The pusher carries a spring that has a front end secured adjacent the front of the track and a coil section carried on the pusher. When the track is loaded with merchandise, the coil of the spring is wound and the wound spring provides stored energy that moves the pusher forward.

### SUMMARY

In merchandising, lighting can be used effectively to emphasize product features, such as color, clarity and the like. Often, lighting is provided by track lights, such as light emitting diodes (LEDs) disposed in proximity with the front of the merchandise shelving. While track lighting is effective to provide illumination, there is a need for alternatives for efficient illumination of product and/or associated containers.

The present invention provides an efficient and effective manner of illuminating products by incorporating a strip of light emitting diodes (LEDs) with a spring tape to provide directed light onto the products closely adjacent the LEDs. When the product containers are clear, the light brightens the contents of the containers, and enables consumers to view the color of the contents prior to purchase. Novel effects can be achieved by directing light upwardly through the bottoms of clear containers.

### BRIEF DESCRIPTION OF THE DRAWINGS

The foregoing and other objects, features and advantages of the present invention should become apparent from the following description when taken in conjunction with the accompanying drawings, in which:

FIG. 1 is a perspective view of a spring powered merchandise display that incorporates an LED tape with a metal spring to illuminate a rank of products from below according to an embodiment;

FIG. 2 is an enlarged, longitudinal cross-sectional view along plane A-A of FIG. 1 showing the LED strip adhesively secured to the metal spring; and

FIG. 3 is a perspective view, similar to FIG. 1, but illustrating a modified version of a spring assembly separated from the product tray according to an embodiment.

### DETAILED DESCRIPTION

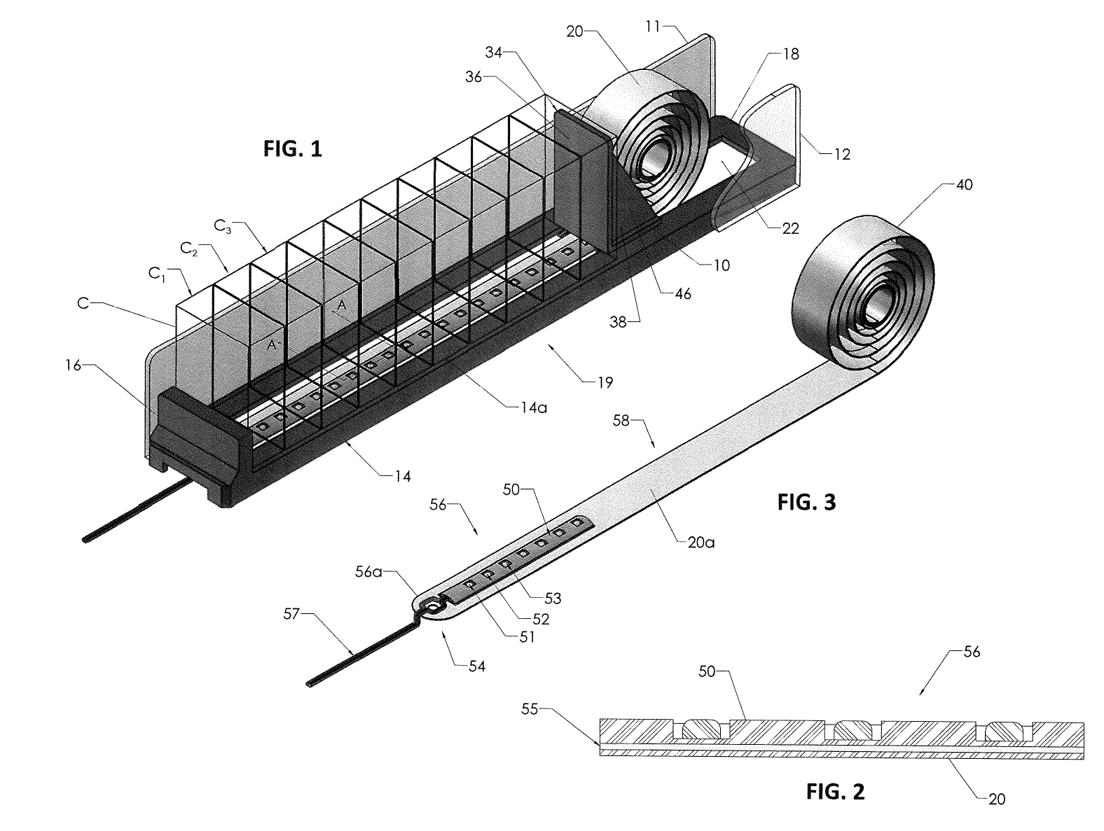

FIG. 1 illustrates a spring-driven pusher tray 19 having a pair of upstanding parallel sidewalls 11, 12 for use in forward feeding merchandise items displayed on a shelf (not shown). For example, several containers of products are positioned in a single file row, or rank, one behind the other, in the tray 19 such that leading containers C₁, C₂, C₃, etc. are located at a front dispensing end of the tray 19. After, the leading box C, is removed from the tray 19 by a purchaser or store clerk, a pusher device 10 urges the rank of remaining containers C₂ and C₃, etc. forward to provide a new leading container adjacent the front end of the tray 19. Although not illustrated, the pusher device 10 of the present invention can also be utilized in up-feeding, side-feeding, or top-feeding merchandise dispensers.

The illustrated embodiment includes an elongate track 14 having a front dispensing end 16, an opposite rear end 18 and an elongate surface 14a supporting the row of containers. Containers are positioned on the track 14 in a row such that the leading article is located adjacent the front end 16 and the rearmost article is located adjacent the rear end 18 of the track 14. Alternatively, the track 14 can be mounted to extend above, or to the side of, the stacked articles on a substantially horizontal or slightly angled, shelf, or the track can be mounted vertically, or at a steep angle relative to the horizontal, for up-feeding a column of stacked articles to a dispensing end.

The pusher device 10 is mounted on the track 14 in a manner which permits movement of the pusher device 10 between the dispensing end 16 and the opposite end 18 of the track 14. Thus, the pusher device 10 is moved rearwardly, or toward the opposite end 18, to load a row of articles on a shelf and is resiliently biased forward, or toward the dispensing end 16, by a spring tape 20.

As best illustrated in FIG. 1, the track 14 includes an elongate slot 22 extending longitudinally, or lengthwise, and utilized to capture a flange extending from the pusher device 10. In this manner, the pusher device 10 engages the surface 14a of the track 14 and is free to slide in a straight path between the front dispensing and opposite rear ends, 16 and 18 respectively, of the track 14. Alternatively, the pusher device may have a pair of side flanges (not shown) which grip about the marginal side edges of the track. This configuration also permits the pusher device to slide in a straight path between the ends of the track.

The pusher device 10 includes a pusher plate 34 that extends upwardly and transversely from the track 14. The pusher plate 34 has a front surface 36 that engages the rearmost article of the row, or rank, of placed containers. The pusher plate 34 also includes spring retaining structure 38 which permits a coiled free end portion 40 of a self-coiling spring, or tape, 20 to be carried on a rear side of the pusher plate 34.

In the illustrated preferred embodiment, the spring retaining structure 38 is carried behind the pusher plate 34 between a pair of spaced apart, parallel retaining flanges, such as flange 46, which extend rearward from the rear side of the pusher plate 34. A terminal free end of the coiled end portion 40 can be either freely nested in the coil shown, or mounted on an arbor (not shown) that extends transversely with respect to the retaining flanges, and mounted to the retaining flanges. Preferably as illustrated, the coiled spring tape engages the rear side of the pusher plate 34 between the retaining flanges to push on the pusher plate, without requiring an arbor.

The free end 54 of an uncoiled portion 58 of the spring 20 remote from the coiled end portion 40 is connected to the track 14 adjacent its dispensing end 16, as by fasteners such as bolts, rivets, or the like. Thus, when the pusher plate 34 is moved rearwardly on the track 14, the spring uncoils and applies a force on the pusher plate 34 in a direction toward the front dispensing end 16 of the track 14, i.e. leftward in FIG. 1.

In a conventional dispenser, the spring tape, or force exerting mechanism, 20 is a flat metal self-coiling spring, or a pre-stressed flat strip of metal, which is formed in a spiral coiled condition. Examples of a metal self-coiling spring include a steel variable force spring or a steel power spring. The pushing force provided by the spring tape 20 preferably, but not necessarily, gradually decreases as the pusher plate approaches the front end 16 of the track 14 and as the spring tape 20 transitions from being fully extended in an un-coiled condition to being fully retracted in a coiled spiral condition. Thus, such a spring advantageously exerts a maximum force when the tray 19 is fully loaded with a full row of articles and exerts a progressively reduced amount of force as the leading articles of the row are removed one by one until all the articles are removed from the tray 19.

The present invention provides a novel structure for illuminating the containers C₁, C₂, C₃, and so on, particularly near the front end of the tray which is most visible to the purchaser. To this end, a flexible strip 50 carrying a series of LEDs 51, 52, 53 in lengthwise spaced relation is secured to the topside 20a of the spring tape 20, as by a flexible adhesive 55. The LED strip 50 and adhesive 55 faun a laminated spring assembly 56, illustrated in longitudinal cross-section in FIG. 2. The spring assembly 56 is flexible and capable of being coiled on itself into a spiral, as shown in FIG. 1. The spiral is formed to be somewhat open to accommodate the thickness of the LED strip as it winds onto itself into the coiled spiral configuration. Due to the LED strip being mounted on the upper, or topside of the spring tape, the LEDs face inwardly when coiled. Although the preferred spring tape is fabricated of metal by known processes, when lighter forces are capable of moving the product items, a so-called “plastic” tape spring may be adequate.

In use, the LEDs are connected in electrical parallel relation on their carrying strip, and power is provided to them via a pair of electrical conductors 57 extending from the mounting end 56a of the spring assembly in the manner illustrated in FIG. 1. The conductors may be connected to a low voltage electrical supply such as a battery, or an A.C. to D.C. power converter located remote from the display. When power is applied, the LEDs light-up and project light upward into the product items disposed above them on the track.

As illustrated in FIG. 1, the LEDs extend for a significant portion of the length of the spring tape, but need not do so. If desired merely to illuminate the frontmost items in the rank, the LED strip may be applied only adjacent the front mounting end 56a of the spring assembly 56, thereby leaving the coilable portion substantially free of LEDs behind the pusher in a region where illumination may not be either necessary or desirable. A construction of this type is illustrated in FIG. 3.

While preferred merchandise dispensers have been described in detail, various modifications, alterations, and changes may be made without departing from the spirit and scope of the present invention as defined in the appended claims.

1. A dispenser, comprising:
a product display tray having a bottom portion for supporting and guiding a rank of product items; and
a spring assembly for advancing the product items forward on the bottom portion;
said spring assembly comprising a pre-stressed spiral tape having a top surface extending from a mounting end portion thereof and a plurality of light emitting diodes carried in spaced relation on a predetermined length of said top surface of said tape for upwardly illuminating product items when disposed in the product display tray.

2. A dispenser according to claim 1, wherein said pre-stressed spiral tape of said spring assembly is made of metal, and wherein said plurality of light emitting diodes are mounted on an elongate flexible strip bonded to said tape.

3. A dispenser according to claim 2, wherein said elongate flexible strip is bonded to said tape by means of a flexible adhesive.

4. A dispenser according to claim 3, wherein said plurality of light emitting diodes are wired in electrical parallel relation, and said flexible strip has conductor wires extending from said mounting end portion of said tape.

5. A spring assembly for illuminating and advancing products, comprising:
an elongate pre-stressed metal tape disposed in a spiral coil with an exposed mounting end portion and a free end portion nested within said coil, and
a flexible strip having a plurality of light emitting diodes, said flexible strip being secured to said metal tape and extending thereon from a location adjacent said mounting end portion for a predetermined length of said spiral coil.

6. A spring assembly according to claim 5, wherein said flexible strip is adhesively bonded to said metal tape for disposing said plurality of light emitting diodes to emit light transversely of said tape as said metal tape is uncoiled.

7. A spring assembly according to claim 5, wherein said metal tape is loosely wound in said spiral coil to accommodate at least some of said plurality of light emitting diodes within said spiral coil when said tape and strip are in operative relation.

8. A spring assembly according to claim 5, wherein said flexible strip extends only partially along a length of said metal tape from its mounting end portion.

9. A spring assembly according to claim 8, wherein said flexible strip extends from a majority of the length of said metal tape from its mounting end portion.
